(19) United States
(12) Patent Application Publication
(10) Pub. No.: US 2006/0077579 A1
(43) Pub. Date: Apr. 13, 2006

(54) Force actuator with clamp

(76) Inventor: Christopher S. Margeson, Sunnyvale, CA (US)

Correspondence Address: Whitham, Curtis & Christofferson, PC, 11491 Sunset Hills Road, Suite 340, Reston, VA, 20190, US

(21) Appl. No.: 10/960,931

(22) Filed: Oct. 12, 2004

(51) Int. Cl. G02B 7/182

(52) U.S. Cl. 359/872

(57) ABSTRACT

A force actuator with clamp in one combined unit that can maintain a specified position without requiring a continuous power supply. Power is only required at times when the position of the shaft of the actuator needs to be changed. As each unit holds position without any external effort, a single controller can operate a plurality of these actuators. Clamping action is arranged coaxially to the force actuator, allowing for a more compact unit such that more of these units can be located in a small space to make fine adjustments.

### BACKGROUND OF THE INVENTION

1. Field of the Invention

The present invention generally relates to a force actuator and clamp for the precision adjustment of various bodies and, more particularly, to a force actuator and clamp combined into one compact unit using minimal power to make and maintain, without application or consumption of power, adjustments in the position of a body or fraction of a body where several force actuators can be applied to the same body and potentially controlled using a single controller.

2. Description of the Prior Art

Higher precision is becoming increasingly required in a wide variety of endeavors including manufacturing processes. For example, as technology has advanced, microprocessor chips and transistors have notably decreased in size while increasing in functionality due to improvements in semi-conductor manufacturing technologies allowing increased integration density. In order to proceed in creating further generations of smaller and more efficient semi-conductors, a higher level of accuracy is becoming increasingly demanded.

Within the semi-conductor manufacturing process, many components of the manufacturing tools, such as lithograph exposure tools, must be regulated to deliver high accuracy so as to transmit optical information accurately as it travels through a series of lenses and/or mirrors. These lenses and mirrors are primarily used to scale the optical information in the transfer. In order to accurately achieve the desired transfer of the pattern to the wafer, the curvature of lenses and mirrors needs to be sensitively regulated.

Most actuators (vcm's, bellows, electromagnets, etc.), including all of the specific devices discussed below, operate in an “always on” condition, requiring a constant input of power, pressure or the like to maintain a desired adjustment. This constant activation generates unwanted disturbances such as heat or thermal deformation, vibration, etc., and a need for a continuous power source. If a large amount of power is needed, precise position adjustment would require multiple controllers which multiplies cost and takes up a large amount of space.

Known techniques for achieving and controlling desired optical performance include a variety of methods and mechanisms. A well-known mechanism is a mirror adjusting fixture, disclosed in U.S. Pat. No. 4,408,832, that implements a piezoelectric stepping section to position the apparatus within a guarding tube, a piezoelectric displacing device for dynamically moving a mirror surface and a piezoelectric clamp to grip a guide projecting from the rear of the mirror. Using this apparatus, the optical surface configuration can be altered by pushing or pulling on the back surface of the mirror.

Another known mechanism is a Fine Figuring Actuator, disclosed in U.S. Pat. No. 4,601,553, comprising a movable control member for contacting the mirror faceplate, and a position controller, which may be in the form of an electrically controlled magnet and coil assembly, operatively interconnecting the control member and a rigid support for the mirror structure; a position sensor operatively interconnects the control member and the mirror support to sense the position of the control member and to provide a corresponding output signal; programmable information processing electronics, responsive to the output signal of the position sensor, provides an input signal to the position controller to move the control member against the faceplate whereby the shape of the faceplate may be controlled according to a preprogrammed scheme applied to electronics. This control device can only apply a curve as determined by one point and the reaction of the support of the mirrored surface. It is also necessary to recognize that the ratio of control units to force actuators by which the force actuators are regulated is one to one.

A third known technique of altering the optical contour, disclosed in U.S. Pat. No. 6,307,688, applies tensile and/or compressive forces parallel to the plane of the optic which rests in a deformable inner ring. A plurality of actuators push or pull on the inner ring to create the desired planar surface. However, this method provides a limited amount of control over the surface for fine or asymmetrical adjustments.

Two other devices are known as means of making small adjustments in position and providing a means of locking this position in place. These techniques are non-specific to dictating optical contours although they can be used in such applications to apply a force in the direction perpendicular to the optic plane. The first of these is a piezomechanical (PZT) locking mechanism that has an actuating rod held stationary by a series of piezoelectric discs threaded around the rod. When an electric field is applied to the discs, the discs undergo lateral shrinkage and the actuating rod is free to move. However, PZTs require constant power. To hold the actuating rod in place, a PZT must be actuated.

The other known apparatus that is often used to regulate the optical contour is the so-called inchworm actuator which considers the problem of the dimensions of actuator units, and how they are generally too large or wide to be placed in close enough proximity to create a detailed curve. As a solution, this apparatus configures the clamping mechanisms in a vertical formation (parallel to the driveshaft), and then redirects the longitudinal clamp-drive to a lateral direction to clamp the position of the driveshaft. However, this apparatus also requires power for activation and possibly multiple controllers.

These known techniques demonstrate the current options for adjusting optical contours through use of various configurations of force actuators. However, as a result of the inherent size, configuration and purpose of these known technologies, not one of these methods can provide an accurate, method for adjusting all areas of the mirror with a simplified control unit and requiring negligible amounts of power. These known devices usually require constant power and a relatively large amount of space; two constraints that greatly impact the design of an adjustable mirror or lens and its surrounding environment while fine, delicate and stable adjustment of relatively smaller regions of an optical element becomes increasingly needed to develop higher optical performance.

### SUMMARY OF THE INVENTION

The present invention provides a combined force actuator and clamping mechanism that is configured coaxially with the shaft which it clamps. Further, the present invention requires power only to activate the actuator driving element and the clamp pusher when a different output force (position change of shaft) is needed. During stationary conditions all actuator/pusher devices are non-active. The present invention further provides the clamping function engaged without need for power, such that one precision controller can operate a plurality of multiplexed actuators. Using pneumatic bellows in the preferred embodiment also allows for a smaller and more compact overall design.

In order to accomplish these and other meritorious functions of the invention, a force actuator is provided with a spring to convert axial displacement of a shaft into a controlled force which may be applied against an object to deform a corresponding region of the object, such as an optical element, the shaft is axially driven by a linear actuator and, after having been driven to a location corresponding to a desired force and deformation of the object while a locking mechanism is held in an unlocked state by a further linear actuator, the shaft is locked in place by a locking mechanism driving wedge-shaped cams against each other thus moving a structure against the shaft. Engagement of the wedge-shaped cams using a spring allows the force against the object to be maintained without application of power to either of the linear actuators or the locking mechanism.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A is a preferred embodiment of the invention when in the “on” position.

FIG. 1B is a preferred embodiment of the invention in the “off” position.

FIG. 2A-2I show the process of assembling the preferred embodiment of the invention.

FIGS. 3A, 4A, 5A, 6A, and 7A show alternate embodiments of the invention in the “on” position.

FIGS. 3B, 4B, 5B, 6B, and 7B show alternate embodiments of the invention in the “off” position.

FIG. 8 shows multiple actuators holding the position of a deformable mirror.

### DETAILED DESCRIPTION OF A PREFERRED EMBODIMENT OF THE INVENTION

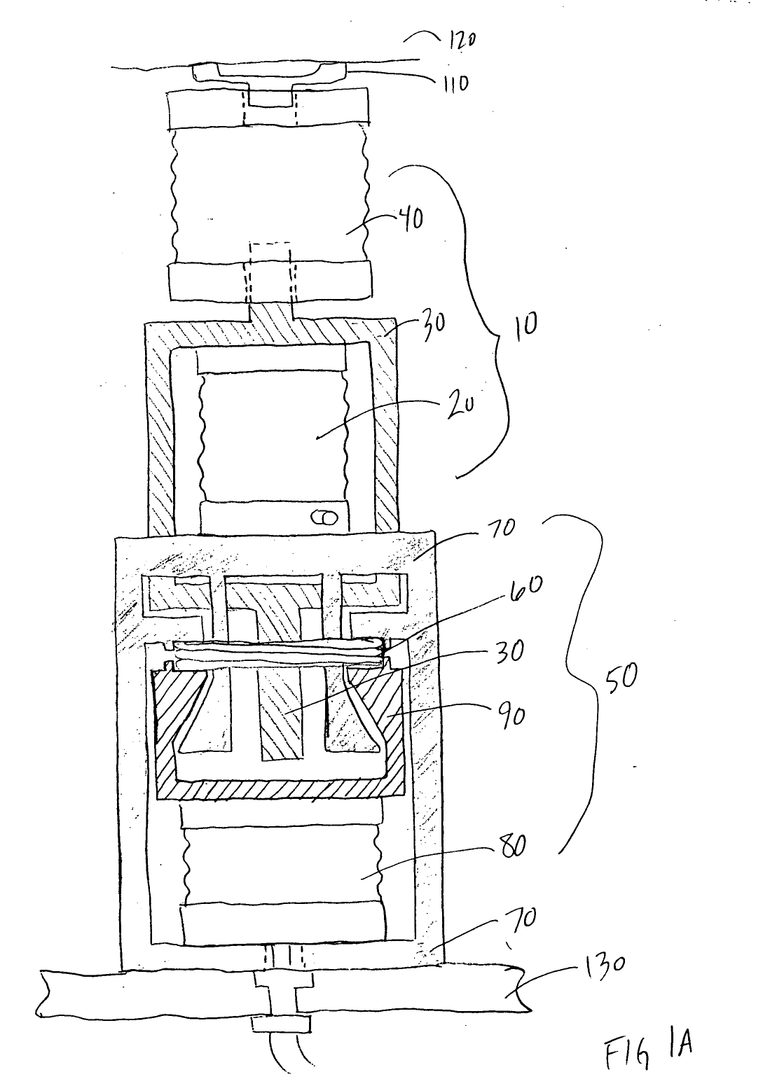

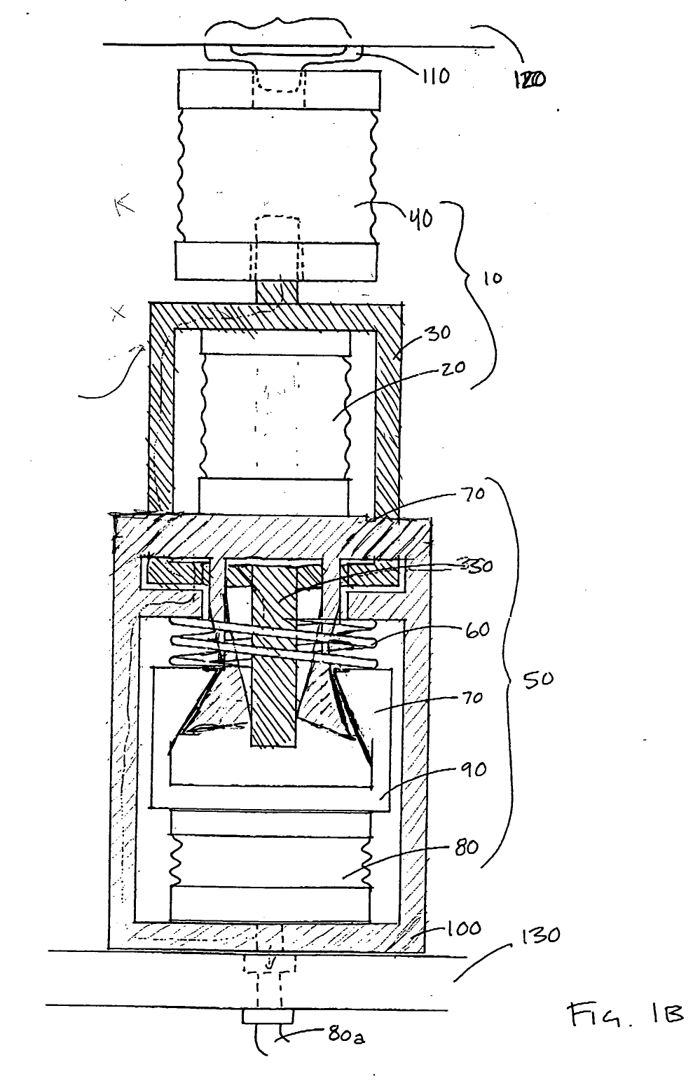

Referring now to the drawings, and more particularly to FIG 1A, there is shown a preferred embodiment of the invention in the “on” position. The “on” position indicates that the shaft 30 is free to move in the direction of its vertical axis allowing the force actuator 10 to dictate the amount of force applied to the object 120, such as a deformable mirror as example although the application of the invention not so limited, and consequently altering the position of an exemplary region 111 of the deformable mirror 120 connected to the force actuator by mounting tab 110. The force actuator 10 consists of three major functioning components: a driving device 20, a shaft 30, and a soft spring 40. The soft spring 40 converts displacement of shaft 30 into a force on object 120. The force actuator can be active (i.e. make adjustments in force) only when the clamping mechanism 50 is deactivated, resulting in the “on” position for the force actuator 10. The driving device 20 can be pneumatic bellows, pzt, pmn, vcm, or other device which can provide linear movement in a positive or negative direction. The soft spring 40 can be a coil-spring, a stack of Belleville washers, bellows or shaft coupling to assure linear stiffness throughout the range of travel. The clamping mechanism is passive, such that when no energy is applied to the clamping mechanism, the shaft 30 is clamped and the force actuator 10 is in the “off” position, as shown in FIG. 1B. Preload spring 60 provides the force necessary to clamp the shaft 30 in order to hold the position of the shaft 30 with no power required. When energy is supplied to the clamping mechanism, the shaft is free to move in a linear fashion, based on the control of the driving device 20 to apply a positive or negative force to the deformable mirror 120.

The clamping mechanism consists of four major functioning components: a clamp or preload spring 60, collet wedge fingers 70, a clamp pusher 80, and a pushing device 90. When the invention is in the “on” condition as shown in FIG. 1A, where the clamping mechanism is deactivated, the clamp pusher 80 is applying an upward force to the pushing device 90. The upward force lifts the pushing device 90 from contact with the collet fingers 70 against clamp or preload spring 60 which, in turn, then release the shaft 30 from the grip of the collet wedge fingers 70, allowing the shaft's position to be determined by the driving device 20. In this system, the clamping mechanism 50 is co-axial with the shaft 30. According to this configuration, the clamp pusher 80 can be pneumatic bellows, voice coil motor (vcm), shape memory actuator, or other device that can change from a passive state, allowing the clamp spring 60 to apply a downward force to clamp the shaft 30, to an active state where the clamp pusher provides a force to overcome the force of the clamp spring 60. As shown in FIG. 1A, for example, pneumatic bellows are utilized as the clamp pusher 80.

Referring now to FIG. 1B, the preferred embodiment of the invention is shown in the “off” position. When “off” no energy is supplied to the clamp pusher 80 providing no resistance to the spring 60, allowing the force of the spring 60 to apply a downward force to the pushing device 90, compressing the clamp pusher 80 and locking the collet fingers 70 which grip the shaft 30, thereby clamping the shaft 30 into place while not causing any axial force on shaft 30. In the off position, no adjustments are made in the position of exemplary region 111 of the deformable mirror 120. As no energy is applied to any part of the invention while in the “off” and clamped position, there is no interference or degradation due to excessive heat, vibration, etc. due to the actuator or clamp.

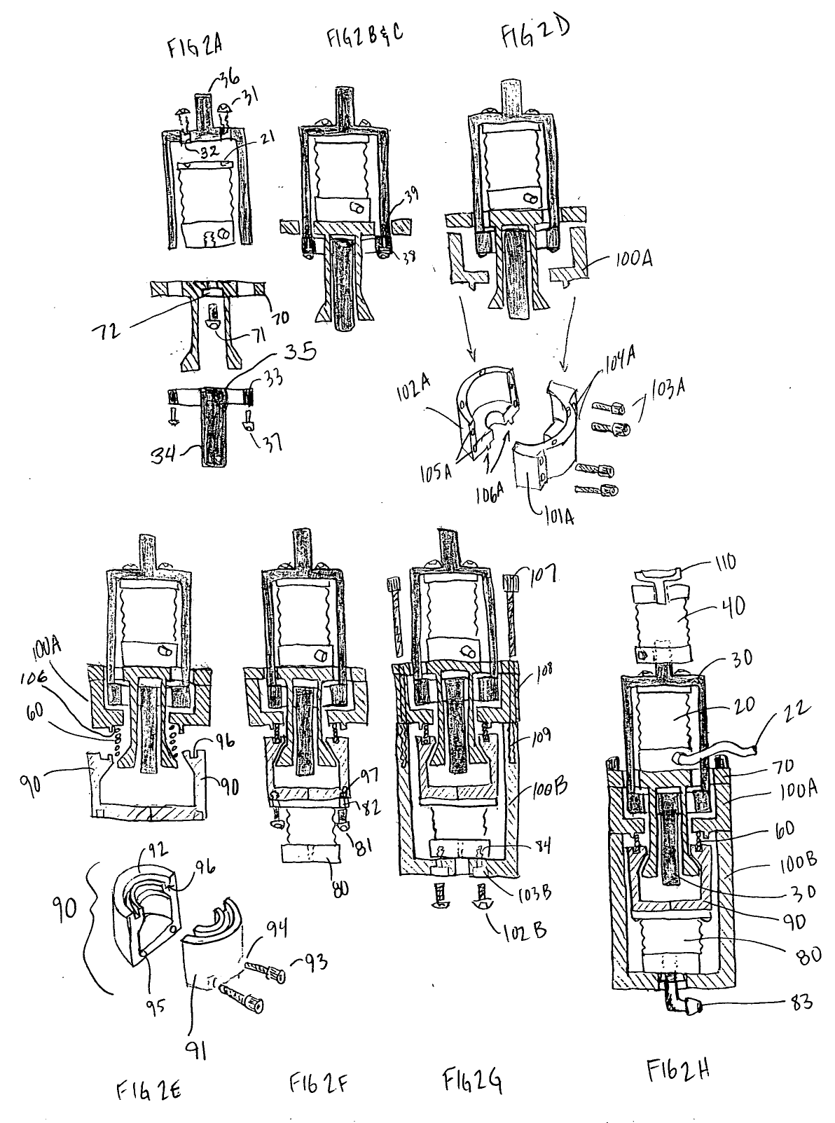

FIGS. 2A-2H illustrate an exemplary process through which the force actuator shown in FIGS. 1A and 1B may be assembled. As shown in FIG. 2A, the collet wedge fingers 70 are attached to the driving device 20 using a screw 71 attached to screw socket 72 embedded within the collet wedge fingers unit 70. This sub-assembly is then attached to the top piece of the shaft 36 from the opposite end of the driving device 20 to the collet wedge finger unit 70 using screws 31 threaded through screw sockets 32 imbedded within the shaft unit to screw sockets 21 imbedded within the top of the driving device 20.

The completion of these steps is shown in FIG. 2B where additional steps are taken to complete the shaft 30 formation. First, the lower shaft piece 34 is threaded into the socket 35 of the middle shaft piece 33. The middle shaft piece is then threaded around the collet fingers 70 until it contacts the bottom of the upper shaft piece 36, thereby completing the enclosure of driving device 20. The lower and middle shaft piece sub-assembly is then attached to the upper shaft 36, using screws 37 threaded through screw sockets 38 in the middle shaft piece 33 to screw sockets 39 in the upper shaft piece as shown in FIG. 2C.

FIG. 2D illustrates the addition of the upper housing 100A. An exploded view of the upper housing 100A is provided, illustrating that the housing is placed around the collet fingers in two pieces 101 and 102 so as to mount around the thin region of the collet fingers 70 and the lower shaft 34 between the flared region of the collet fingers and the middle shaft 33. These two pieces 101 and 102 are attached by screws 103 threaded through screw sockets 104 in section 101 of piece 100A to screw socket 105 in section 102.

The clamp spring 60 is then threaded around the collet fingers sub-assembly as shown in FIG. 2E followed by the assembly of pushing device 90. Pushing device 90 is assembled from two semi-cylindrical components 91 and 92 matched together over and enclosing the flared end of the collet fingers. The components are fastened together using screws 93 threaded through screw sockets 94 in semi-cylinder 91 to screw sockets 95 in semi-cylinder 92. The spring is not fixed to either the upper housing 100A or the pushing device 90, but is held in position between the two, resting in trench area 106 of the upper housing and trench area 96 of the pushing device.

FIG. 2F illustrates the next step of attaching the clamp pusher 80 to the pushing device 90 using screws 81 threaded through screw sockets 82 of the clamp pusher 80 to screw socket 97 of the pushing device. Finally, as shown in FIG. 2G, an open-ended cylinder constituting the lower housing 100B is attached to the upper housing 100A using long screws 107 threaded through screw sockets 108 in the upper housing 100A to screw socket 109 in the lower housing 100B. By adding the lower housing, all moving components other than the shaft are enclosed to avoid potential interference, as well as to create a specified area for the clamp spring 60 and the clamp pusher 80 to push against for support.

The force actuator with clamp is completed by attaching the soft spring 40 to the shaft 30 and attaching a mounting tab 110 to the soft spring 40 as interface between the shaft 30 of the force actuator 10 and the region 111 of the deformable mirror. Paths 83 and 22 are created to supply pressurized air to the preferred pneumatic bellows to control movement of the clamp pusher 80 and driving device 20, respectively.

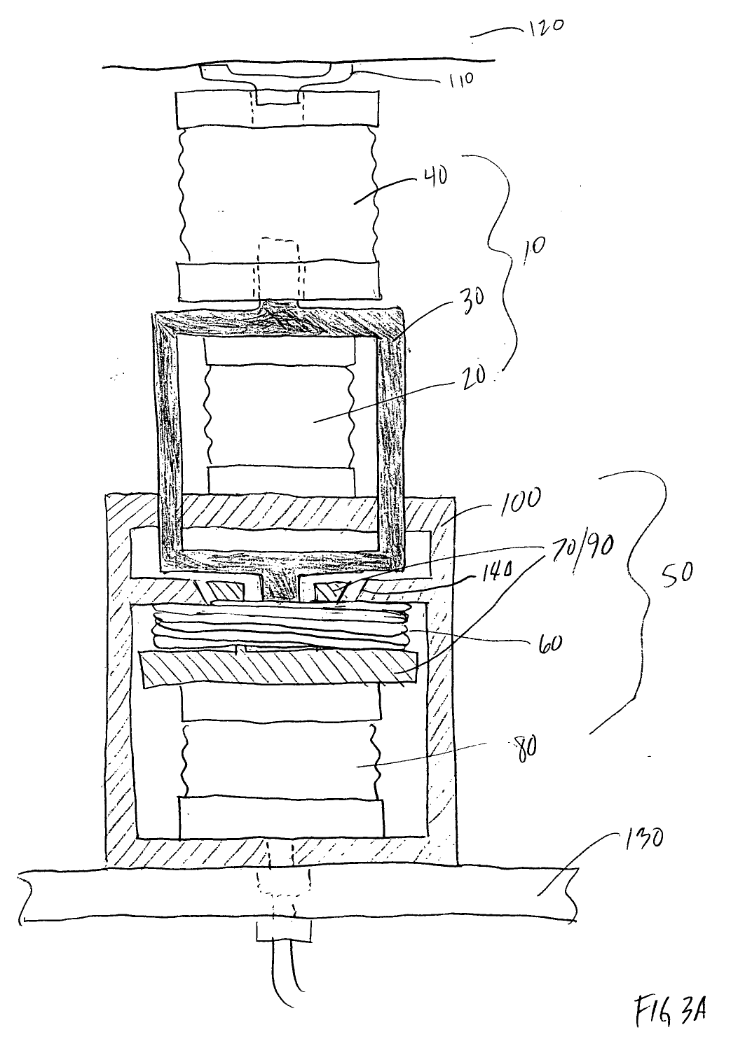

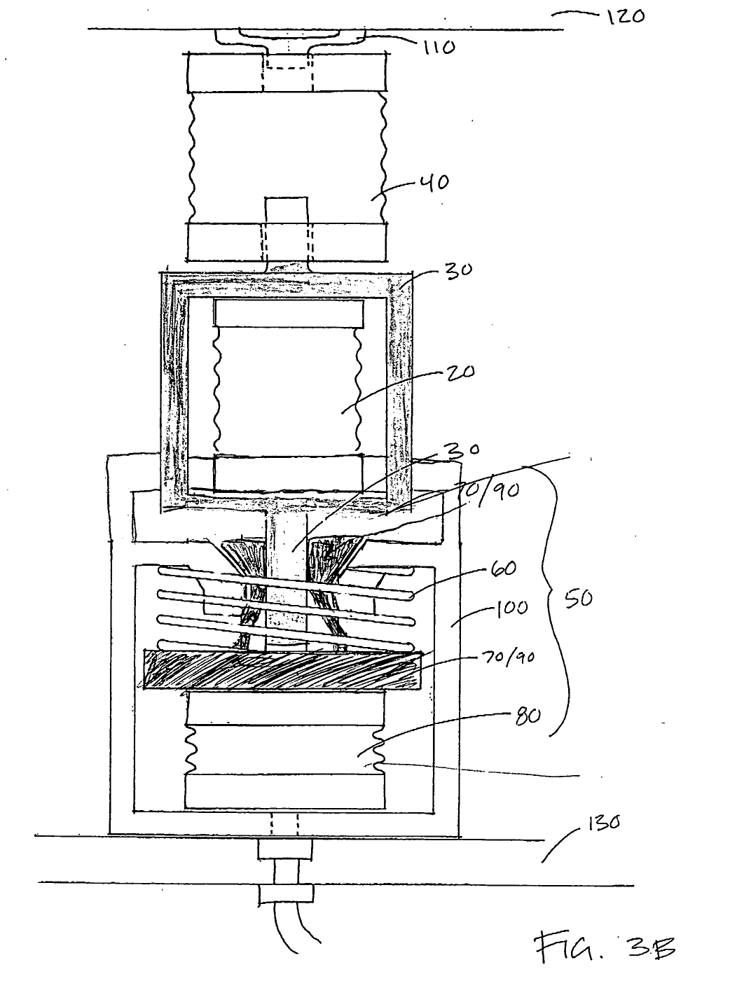

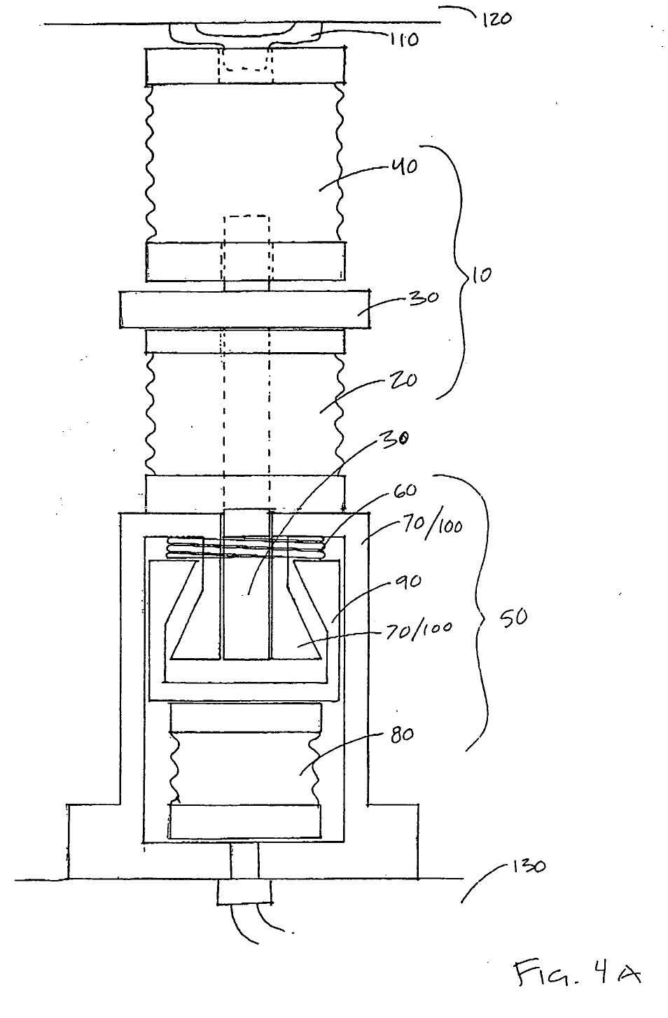

FIGS. 3A and 3B illustrate an alternate embodiment of the invention in the “on” position and “off“ position respectively. In this embodiment, the collet wedge fingers 70 are in a reversed orientation as compared with the preferred embodiment so that the collet wedge fingers 70 and the pushing device 90 are one unit. In this embodiment, the complementing wedge 140 acting on the collet wedge fingers 70 and incorporated in the pushing device 90 in the preferred embodiment of FIGS. 1A and 1B is stationary and incorporated into the housing 100 in this alternate embodiment. The clamping effect is the same as in the preferred embodiment.

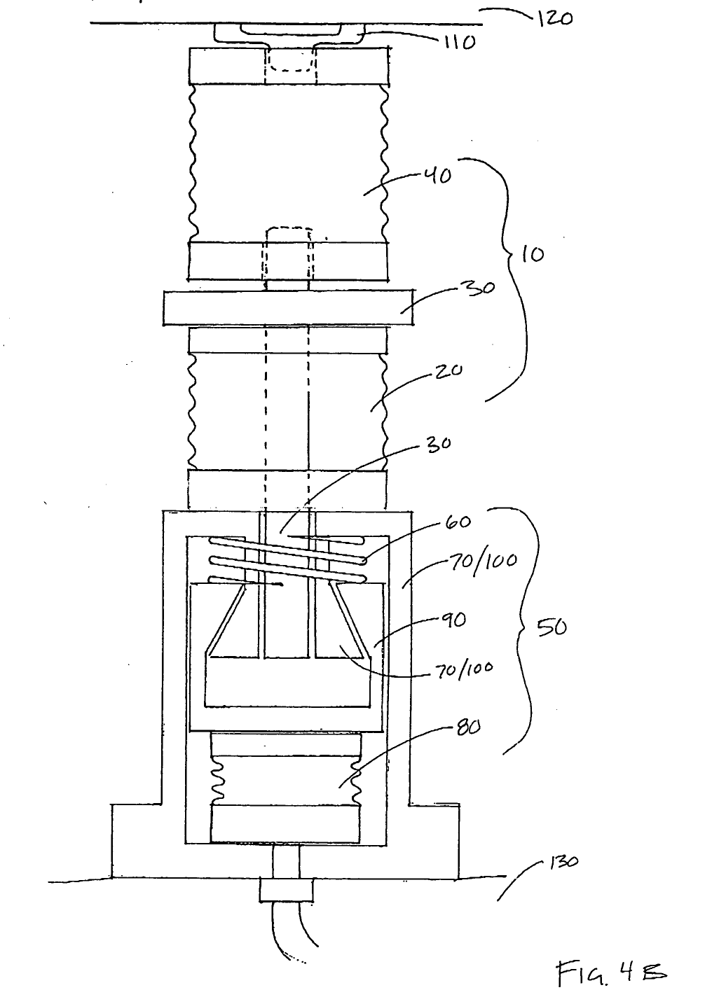

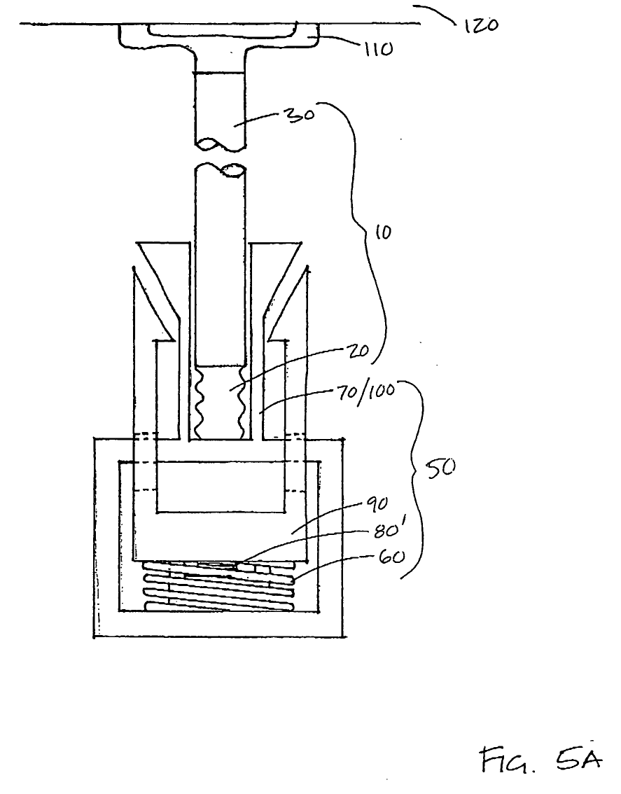

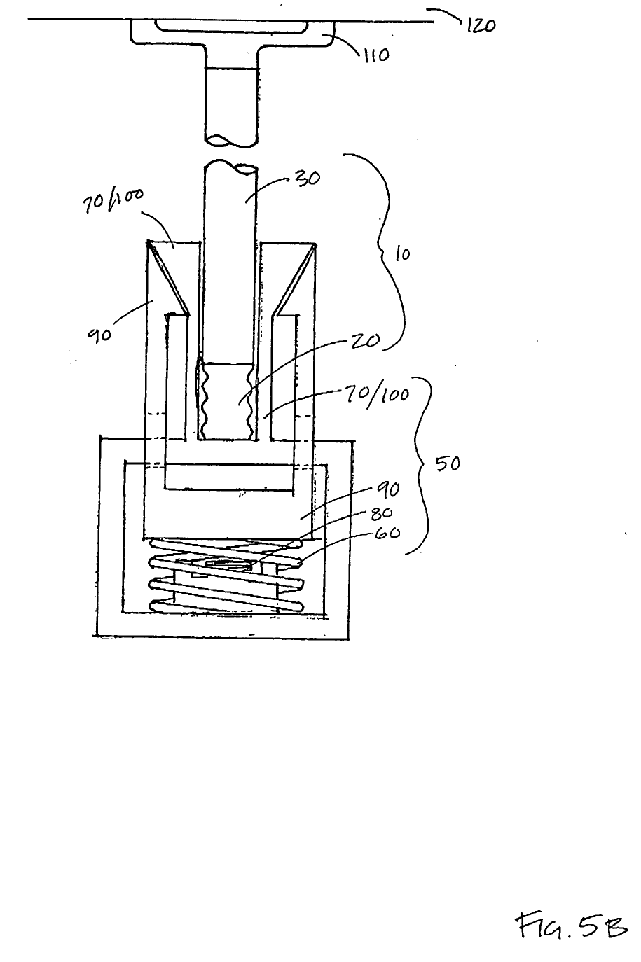

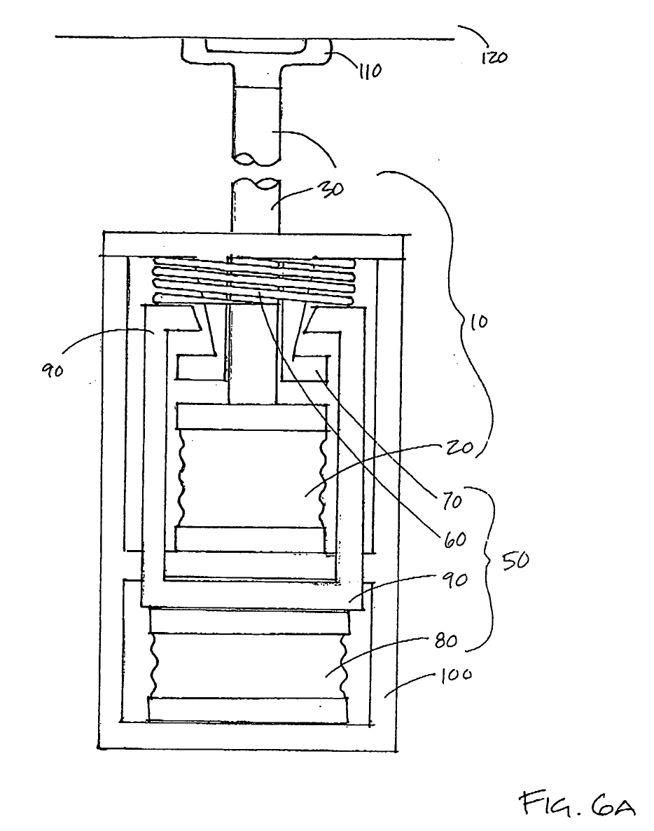

FIGS. 4A and 4B illustrate another alternate embodiment of the invention in which the collet wedge fingers 70 are in the same orientation as the preferred embodiment shown in FIGS. 1A and 1B. However, in this embodiment, the collet wedge fingers 70 are incorporated into the same unit as the housing structure 100. Additionally, the driving device 20 is not enclosed as it is in the preferred embodiment. FIG. 4A shows this embodiment in the “on” position and FIG. 4B depicts the “off” position.

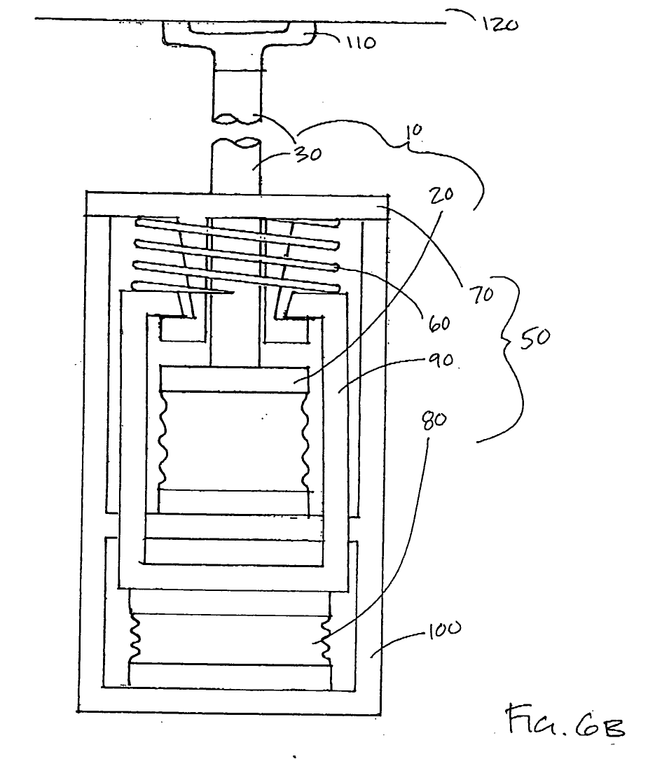

FIGS. 5A and 5B illustrate another alternate embodiment of the invention in the “on” and “off” positions respectively. This embodiment is notably different from the preferred embodiment in that the clamp spring 60 and the clamp pusher (more accurately described as a clamp puller in this embodiment) 80′ are located on the same side of the pushing device. This is possible by using an E-I core electromagnet as the clamp puller 80′. When the electromagnet 80′ is activated, as shown in FIG. 5A, the pushing mechanism 90 is pulled down, releasing the collet wedge fingers 70. Likewise, when the electromagnet is deactivated, the spring 60 pushes the pushing device 90 upward to force the collet wedge fingers 70 onto the shaft, thereby clamping it into place. The collet wedge fingers 70 are incorporated into the housing structure 100 in this embodiment. A unique feature of this embodiment is in how the collet wedge fingers 70/100 grip the shaft 30 above the driving device 20. The driving device is also located entirely below the shaft 30 in this embodiment.

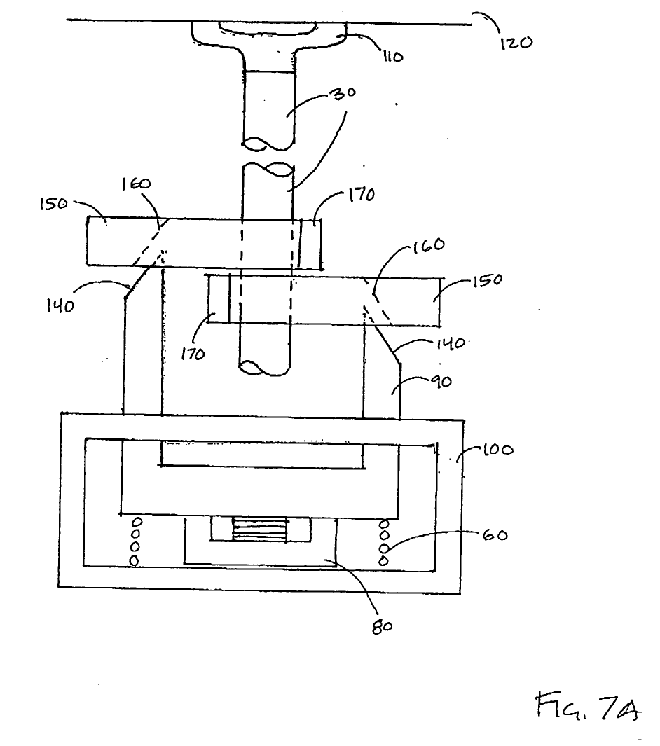

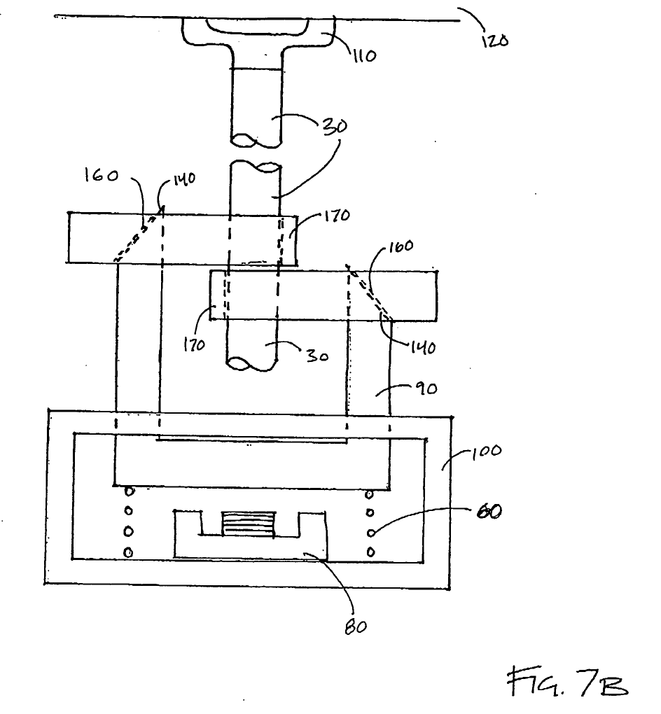

FIGS. 6A and 6B show another alternate embodiment of the invention in the “on” and “off” positions, respectively. This configuration also has the driving device 20 located underneath the shaft 30 and the clamping action of the collet wedge fingers 70 therefore occurring above the driving device, as in the embodiment of FIGS. 5A and 5B. This embodiment differs from the embodiment of FIGS. 5A and 5B in that all of the moving components are enclosed except for the shaft 30. This embodiment also uses the original orientation of the collet wedge fingers 70 as shown in the preferred embodiment of FIGS. 1A and 1B.

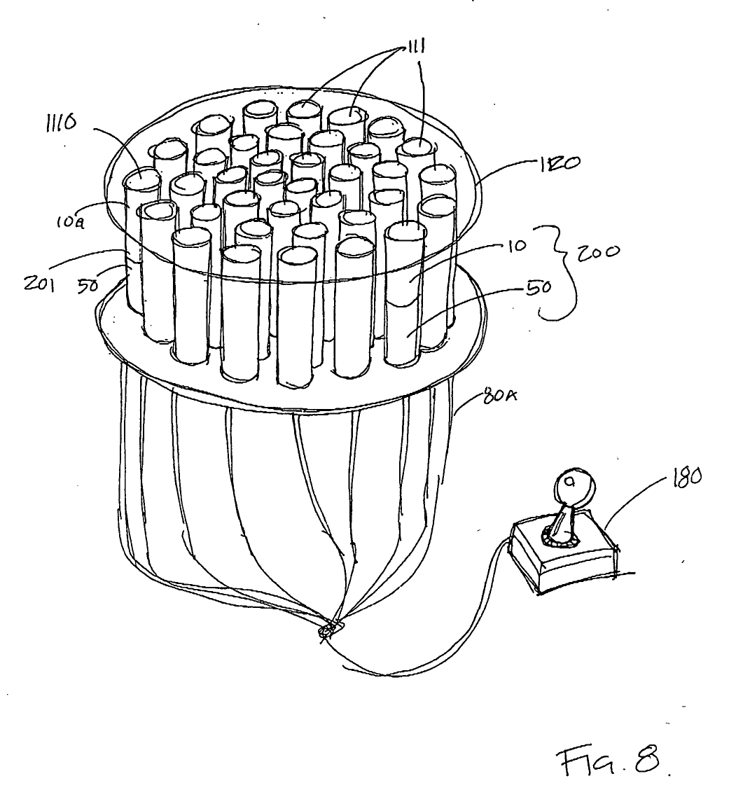

FIGS. 7A and 7B show another alternate embodiment of the invention in “on” and “off” positions, respectively, utilizing a modified clamping mechanism. Rather then using collet wedge fingers to push directly onto the shaft 30 for clamping when pressed by the complementing wedge 140 of the pushing device 90, collet rings 150 are used. These rings have an interior surface angled similarly to the collet wedge fingers, but the structure is set up such that the complementing wedge 140 pushes the wedge region 160 of the collet ring 150 away rather than toward the shaft 30. The collet ring however surrounds the shaft in such a way that when the wedge region 160 is pushed away from the shaft, the opposite side of the ring becomes the clamping area 170. Multiple collet rings must be used from multiple sides of the shaft to achieve effective clamping in this embodiment.

FIG. 8 shows an exemplary arrangement of the force actuators with clamps arranged underneath a deformable mirror. When the mirror does not require adjustment, all of the force actuator with clamp units 200 are “off” and require no power or energy to be applied to them. When the deformable mirror 120 requires adjustment, any of the regions 111 can be selected and repositioned through use of a controller 180. The appropriate force actuator (e.g. 10a) with clamp unit 200 is selected using the controller 180, and then the specified unit 201 is turned “on” and the clamping mechanism 50 is released, allowing the force actuator 10 to change the position of area 1110 in the positive or negative direction. When the position is changed to the desired specifications, the unit 201 is turned “off” again and resumes its clamped status in the new position. This process can then be repeated to alter the location of the other regions 111 of the deformable mirror, one at a time, using the same controller. Alternatively, of course, multiple controllers can be used to performed an equal number of simultaneous adjustments or each actuator may be simultaneously controlled by a corresponding dedicated actuator.

In view of the foregoing, it is seen that the invention combines the force actuator and clamp in an orientation that allows for compact packaging such that many of these actuator and clamping units can be arranged in a tight configuration. Pneumatic bellows are particularly suited to this invention, especially in the preferred embodiment, as they allow for an even smaller and more compact overall design. Further, as the actuator units are clamped in a “off” position when at rest and do not require any additional input to maintain the clamped position such that one precision controller can be used to control a plurality of actuator units in turn. These novel features are particularly important in lowering operating costs, saving space (both through an axial clamping configuration and use of a single controller), and avoiding excess heat by using minimal power which can otherwise have undesirable effects upon these mechanisms and other components of the machine of which they are part. As these actuators are used to create very small (in the range of nanometers) position alterations, any factors creating disturbance to the actuator puts the accuracy of the machine in high risk.

While the invention has been described in terms of a single preferred embodiment and several alternative embodiments, those skilled in the art will recognize that the invention can be practiced with modification within the spirit and scope of the appended claims.

Having thus described my invention, what I claim as new and desire to secure by Letters Patent is as follows:

1. An apparatus for changing the position of a specified point of an object comprising:
a force actuator comprising
a driving device, and
a shaft, and
a clamping mechanism,
a clamp spring,
a wedge driven clamping mechanism,
a clamp pusher, and
a pushing device,
a mounting tab, and
a reaction plate,
wherein a plurality of said apparatuses may be controlled by a single controller or multiple controllers.

2. An apparatus as recited in claim 1 wherein said object is a deformable mirror or lens.

3. An apparatus as recited in claim 1 said force actuator further comprises a soft spring.

4. An apparatus as recited in claim 1 wherein said wedge driven clamping mechanism is a set of collet wedge fingers.

5. An apparatus as recited in claim 1 wherein said wedge driven clamping mechanism is a set of collet rings.

6. An apparatus as recited in claim 1 wherein said force actuator and said clamping mechanism have co-axial orientation.

7. An apparatus as recited in claim 1 wherein said driving device is one of pneumatic bellows, pzt, pmn, and vcm.

8. An apparatus as recited in claim 1 wherein said clamp pusher and said clamp spring act on opposite ends of said pushing device.

9. An apparatus as recited in claim 8 wherein said clamp pusher is one of pneumatic bellows, vcm, shape memory actuator.

10. An apparatus as recited in claim 1 wherein said clamp pusher and said clamp spring act on the same end of said pushing device.

11. An apparatus as recited in claim 10 wherein said clamp pusher is an electromagnet.

12. A apparatus as recited in claim 11 wherein said electromagnet has an E-I shaped core.

13. An apparatus as recited in claim 3 Wherein said soft spring is one of a coil-spring, stack of Belleville washers, bellows, and shaft coupling.

14. A method for altering the surface shape of an object and preserving the altered position of said surface shape of said object, said method comprising steps of:
activating a clamp pusher to release a clamping mechanism,
activating a driving device to move a shaft in either a positive or negative linear direction, and
deactivating said clamp pusher to engage said clamping mechanism of said apparatus,
wherein said plurality of actuators are attached and apply selected forces to selected portions of said object at a plurality of locations.

15. The method as recited in claim 13, wherein said actuator is selected from a plurality of actuators by a controller.

16. An apparatus comprising:
an optical element;
a spring element mechanically coupled to said optical element, said spring element being configured to exert a controlled displacement force on said optical element
a shaft;
a driving device configured to compress said spring element by driving the shaft to create said controlled displacement force on the optical element such that said optical element deforms to a desired position; and
a locking element, coupled to the shaft and configured to lock said shaft in position after said optical element is deformed to said desired position.

17. The apparatus as recited in claim 16, wherein the locking mechanism is configured to be unlocked when said driving device is driving said spring element to create said controlled displacement force.

18. The apparatus as recited in claim 16, wherein the driving device is further configured to be turned off after said shaft is locked into place by said locking mechanism.

19. The apparatus as recited in claim 18, wherein said locking mechanism includes a first wedge-shaped member which is displaced by contact with a second wedge-shaped member.

20. The apparatus as recited in claim 19, wherein said first wedge-shaped member is driven against said shaft by contact with said second wedge-shaped member.
